(19) United States
(12) Patent Application Publication
(10) Pub. No.: US 2007/0281054 A1
(43) Pub. Date: Dec. 6, 2007

(54) Organic powder nutritional formula containing select carbohydrate combinations

(75) Inventors: Jeffrey M. Boff, Dublin, OH (US); Christine L. Clinger, Delaware, OH (US); Cynthia J. Black, Westerville, OH (US); Cathy S. Lamb, Westerville, OH (US)

Correspondence Address: ROSS PRODUCTS DIVISION OF ABBOTT LABORATORIES;DEPARTMENT 108140-DS/1, 625 CLEVELAND AVENUE, COLUMBUS, OH, 43215-1724, US

(73) Assignee: Abbott Laboratories

(21) Appl. No.: 11/444,001

(22) Filed: May 31, 2006

(51) Int. Cl. A23L 1/30

(52) U.S. Cl. 426/72

(57) ABSTRACT

Disclosed are organic powder nutritional formulas, including infant formulas, comprising organic lipid, organic protein, and organic carbohydrate, wherein the organic carbohydrate is a blend containing at least one carbohydrate selected from organic maltodextrin, organic corn syrup solids, and organic corn syrup, and at least one carbohydrate selected from organic sucrose and organic lactose. The organic powder nutritional formulas provide improved physical appearance due to less granular residue and improved dispersibility.

### TECHNICAL FIELD

The present invention relates to organic powder nutritional formulas containing select organic carbohydrate combinations for improved dispersibility and improved physical appearance due to less granular residue.

### BACKGROUND OF THE INVENTION

A variety of nutritional formulas are commercially available today. These formulas typically contain a balance of proteins, carbohydrates, lipids, vitamins, and minerals tailored to the nutritional needs of the intended user, and include product forms such as ready-to-drink liquids, reconstitutable powders, nutritional bars, and others. Among the many nutritional formulas commercially available today, infant formulas have become particularly well known and commonly used in providing a supplemental, primary, or sole source of nutrition early in life.

Organic nutritionals, in particular, have become increasingly popular among a growing population of health conscious consumers. Organic nutritionals are made from organic ingredients which are grown and prepared without the use of chemical pesticides, growth hormones, antibiotics, herbicides or synthetic fertilizers, are processed without the use of solvents, and are not genetically modified. A growing number of individuals are turning to organic foods as their preferred source of nutrition because the consuming public is aware that organic foods reduce the health risks associated with consuming foods that are potentially tainted with chemical solvents, pesticides, herbicides, and the like.

A number of countries have procedures and regulations that must be followed for a food product to be labeled as organic. The United States Department of Agriculture National Organic Program (USDA NOP) has developed national organic standards and established an organic certification program. The USDA NOP regulations require that products labeled as “organic” must contain at least 95 percent organically produced raw or processed agricultural ingredients. Any remaining product ingredients must be organically produced, unless not commercially available in organic form. The USDA's 95% requirement is consistent with the standards in Japan, the European Union, and Canada.

An increasing number of organic food products have become commercially available, including organic infant formulas as well as other organic nutritional formulas. These products tend to have limited distribution and are costly. This is due, in part, to limited availability of organic ingredients in sufficient quantities for use in such products. Organic ingredients are not as readily available on a large-scale basis, because only approximately 4% of the world's farmers practice organic farming. Furthermore, since organic food products are prepared without the use of chemical pesticides, growth hormones, antibiotics, herbicides or synthetic fertilizers and are processed without the use of solvents, the physical appearance and physical quality of some organic food products may be inferior to some non-organic food products, thus further limiting the supply of acceptable organic ingredients for use in an organic food product.

Organic infant formulas have become increasingly popular as a commercially available organic food product. As a regulated food product, organic or otherwise, infant formulas must contain a defined balance of fats, proteins, carbohydrates, vitamins, and minerals. Most organic infant formulas typically contain organic lactose as the sole added carbohydrate source. The use of organic lactose, however, especially at the higher concentrations used in organic infant formulas, is limited by high material costs and limited commercial availability.

It would therefore be desirable to formulate an organic infant formula or other organic nutritional formula with an alternative carbohydrate source such as organic maltodextrin, organic corn syrup solids, organic corn syrup, or combinations thereof, supplies of which are more readily available than current organic lactose supplies. It has been discovered, however, that use of these alternative organic carbohydrate sources, unlike organic lactose, results in increased granular residue formation and reduced product dispersibility, especially when formulated into an organic powder nutritional emulsion comprising organic fat, organic protein, and organic carbohydrate.

It has now been discovered herein that one method for improving the undesirable physical appearance, i.e., granular residue, and inferior dispersibility of an organic powder nutritional product containing alternative carbohydrate sources such as organic maltodextrin, organic corn syrup, and/or organic corn syrup solids, is to use additional carbohydrate sources in the formulation. It has now been found that organic powder nutritional formulas containing organic maltodextrin, organic corn syrup solids, and/or organic corn syrup can be formulated in combination with organic lactose, organic sucrose, or both, to effectively minimize or eliminate granular residue in the final organic powder nutritional product and to improve dispersibility.

### SUMMARY OF THE INVENTION

The present invention is directed to organic powder nutritional formulas, including organic powder infant formulas, comprising organic lipid, organic protein, and organic carbohydrate, wherein the organic carbohydrate is a blend containing at least one ingredient selected from organic maltodextrin, organic corn syrup solids, and organic corn syrup, and at least one ingredient selected from organic sucrose and organic lactose.

It has been found that the alternative organic carbohydrate sources described, when formulated into an organic powder nutritional emulsion, result in granular residue formation and reduced dispersibility. It has also been found, however, that the organic powder nutritional formulas of the present invention, which are formulated with alternative carbohydrate sources other than or in addition to lactose, have improved physical appearance due to less granular residue and improved dispersibility. It has been found, in particular, that organic powder nutritional formulas containing organic maltodextrin, organic corn syrup solids, and/or organic corn syrup can be formulated in combination with either organic lactose, organic sucrose, or both, to effectively minimize or eliminate granular residue in the final organic powder nutritional product and to improve dispersibility.

### DETAILED DESCRIPTION OF THE INVENTION

The organic powder nutritional formulas of the present invention comprise organic lipid, organic protein, and select combinations of organic carbohydrates. These and other essential or optional elements or limitations of the organic powder nutritional formulas of the present invention are described in detail hereinafter.

The term “infant” as used herein, unless otherwise specified, refers to children not more than about one year of age, and includes infants from 0 to about 4 months of age, infants from about 4 to about 8 months of age, infants from about 8 to about 12 months of age, low birth weight infants at less than 2,500 grams at birth, and preterm infants born at less than about 37 weeks gestational age, typically from about 26 weeks to about 34 weeks gestational age. The term “child” and “children” as used herein refers to children not more than 12 years of age, and includes children from about 12 months to about 12 years of age. The term “adult” as used herein refers to adults and children about 12 years and older.

The term “infant formula” as used herein, unless otherwise specified, refers to a nutritional composition designed for infants that contains sufficient nutrients such as proteins, carbohydrates, lipids, vitamins, and minerals to potentially serve as a supplemental, primary, or sole source of nutrition.

The term “organic infant formula” as used herein, unless otherwise specified, refers to an infant formula comprising at least 95 percent (by weight, excluding water) organically produced, raw or processed, agricultural ingredients. Any remaining product ingredients must be organically produced, unless not commercially available in organic form.

The term “nutritional formula” as used herein, unless otherwise specified, refers to a nutritional composition designed for infants, toddlers, children, adults, or combinations thereof, that contains sufficient nutrients such as proteins, carbohydrates, lipids, vitamins, minerals, and electrolytes to potentially serve as a supplemental, primary, or sole source of nutrition.

The term “organic nutritional formula” as used herein, unless otherwise specified, refers to a nutritional formulation comprising at least 95 percent (by weight, excluding water) organically produced, raw or processed, agricultural ingredients. Any remaining product ingredients must be organically produced, unless not commercially available in organic form.

The term “organic” as used herein, unless otherwise specified, in reference to any individual organic raw ingredient, refers to a raw ingredient obtained from a producer or handler of a production or handling operation that has produced or handled the raw ingredient, under an organic production or organic handling system plan that is agreed to by the producer or handler and an accredited certifying agent.

The term “non-GMO” as used herein, Unless otherwise specified, in reference to a non-organic agricultural raw ingredient, refers to an ingredient that is not produced from a genetically modified organism. Non-organic agricultural raw ingredients for use herein are preferably non-GMO.

The term “non-GMO” as used herein, unless otherwise specified, in reference to a non-organic, non-agricultural raw ingredient, refers to an ingredient that is free from modified deoxyribonucleic acid (DNA) or the proteins from genetically modified DNA. Non-organic, non-agricultural, raw ingredients for use herein are preferably non-GMO.

The term “ready-to-feed” as used herein, unless otherwise specified, refers to nutritional formulas in liquid form suitable for administration, including reconstituted powders, diluted concentrates, and manufactured liquids.

All percentages, parts and ratios as used herein, are by weight of the total composition, unless otherwise specified. All such weights as they pertain to listed ingredients are based on the active level and, therefore, do not include solvents or by-products that may be included in commercially available materials, unless otherwise specified.

All weight ratios or weight percentages, as used herein for the organic carbohydrate combinations, unless otherwise specified, are based on organic carbohydrates that are added to the organic powder nutritional formulas as individual organic carbohydrate ingredients and do not include inherent organic carbohydrates provided from other added ingredients, e.g., inherent lactose provided from added organic non-fat dry milk.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The organic powder nutritional formulas of the present invention may also be substantially free of any optional or selected essential ingredient or feature described herein, provided that the remaining formula still contains all of the required ingredients or features as described herein. In this context, and unless otherwise specified, the term “substantially free” means that the selected composition contains less than a functional amount of the optional ingredient, typically less than 0.1% by weight, and also including zero percent by weight of such optional or selected essential ingredient.

The organic powder nutritional formulas and corresponding methods of the present invention can comprise, consist of, or consist essentially of the essential elements and limitations of the invention described herein, as well as any additional or optional ingredients, components, or limitations described herein or otherwise useful in organic powder nutritional formula applications.

### Carbohydrates

The organic powder nutritional formulas of the present invention comprise at least one organic carbohydrate (first carbohydrate) selected from organic maltodextrin, organic corn syrup, and organic corn syrup solids, and at least one organic carbohydrate (second carbohydrate) selected from organic sucrose and organic lactose. These carbohydrate combinations, as selected and defined herein, provide an organic powder nutritional formula with improved physical appearance due to less granular residue and improved dispersibility.

The organic powder nutritional formulas of the present invention comprise organic lipid, organic protein, and organic carbohydrate, wherein the organic carbohydrate is a blend containing at least one carbohydrate selected from organic maltodextrin, organic corn syrup solids, and organic corn syrup, and at least one carbohydrate selected from organic sucrose and organic lactose. The preferred weight ratio of organic maltodextrin, organic corn syrup solids, and/or organic corn syrup to organic sucrose, organic lactose, or both, is from about 1:10 to about 10:1, more preferably from about 5:1 to about 1:3, including from about 3:1 to about 1:1.

The organic powder infant formulas of the present invention comprise organic lipid, organic protein, and organic carbohydrate, wherein the organic carbohydrate is a blend of organic maltodextrin and organic sucrose. The weight ratio of organic maltodextrin to organic sucrose preferably ranges from about 1:10 to about 10:1, more preferably from about 5:1 to about 1:3, including from about 3:1 to about 1:1.

The weight ratios, as used herein for the organic carbohydrate combinations, are based on organic carbohydrates that are added to the organic powder nutritional formulas as individual organic carbohydrate ingredients and do not include inherent organic carbohydrates provided in other added ingredients. A non-limiting example of an inherent organic carbohydrate that is not included in the weight ratios, as used herein, is inherent lactose provided from added organic non-fat dry milk.

The organic carbohydrates for use in the organic powder nutritional formulas of the present invention may be obtained from any known or otherwise suitable certified organic material source for use in organic powder nutritional formulas. The organic carbohydrates must be obtained from a producer or handler of a production or handling operation that has produced or handled the carbohydrate, under an organic production or organic handling system plan that is agreed to by the producer or handler and an accredited certifying agent. A limited number of commercial certified sources are available.

The organic powder nutritional formulas of the present invention may comprise organic lactose, a disaccharide consisting of two subunits, a galactose and a glucose linked together by a glycosidic bond. Organic lactose for use in the organic powder nutritional formulas of the present invention is typically derived or otherwise obtained from cow's milk, which generally contains about 5% lactose. The organic lactose can be added in purified or partially purified form. A limited number of commercial sources of organic lactose are available because there are only a limited number of commercial sources of cow's milk, from which lactose is derived, which do not use hormones, steroids or antibiotics on the cattle and only feed organic grains and grasses to the cattle. Non-limiting examples of some suitable sources of organic lactose include organic lactose from Marroquin International, Santa Cruz, Calif. USA; and organic lactose from Horizon Dairy, Boulder, Colo., USA.

The organic powder nutritional formulas of the present invention may comprise organic sucrose, a disaccharide consisting of two subunits, a fructose and a glucose linked together by a glycosidic bond. Organic sucrose for use in the organic powder nutritional formulas of the present invention is typically extracted from organic sugar cane or organic sugar beet and then purified and crystallized. Non-limiting examples of some suitable sources of organic sucrose include organic sucrose from Florida Crystals, West Palm Beach, Fla., USA; and organic sucrose from Marroquin International, Santa Cruz, Calif. USA. Organic sucrose is preferred over organic lactose. Although organic lactose is suitable for use herein, the compositions are preferably substantially free of added organic lactose. In this context, the formulas of the present invention preferably contain less than 1.0%, including less than 0.5%, and also including zero percent, by weight of added organic lactose.

The organic powder nutritional formulas of the present invention may comprise organic corn syrup, known as glucose syrup outside Canada and the United States. Organic corn syrup is derived from partial hydrolysis of organic corn starch and is composed mainly of glucose. A limited number of commercial sources of organic corn syrup are available because organic corn syrup must be derived from an organic corn crop. Non-limiting examples of some suitable sources of organic corn syrup include organic corn syrup from Agrana Beteiligungs-AG, Vienna, Austria; and organic corn syrup from Marroquin International, Santa Cruz, Calif., USA.

The organic powder nutritional formulas of the present invention may comprise organic maltodextrin. Maltodextrins are partially hydrolyzed starch molecules, comprising a series of D-glucose units linked primarily by alpha-1-4 bonds, that are dried to a low moisture powder. Maltodextrins, as an ingredient class, are not sweet and have DE values of less than 20. DE values are conventional measurements of the average reducing power of maltodextrin or other polysaccharide as compared to a dextrose standard. Organic maltodextrins having DE values of about less than 20 are suitable for use herein.

Organic maltodextrins suitable for use in the organic powder nutritional formulas of the present invention may be derived from any known or otherwise suitable organic source such as organic corn, organic rice or organic potatoes. Non-limiting examples of some suitable sources of organic maltodextrin include organic corn maltodextrin from Agrana Beteiligungs-AG, Vienna, Austria; and organic rice maltodextrin from California Natural Products, Lathrop, Calif., USA.

The organic powder nutritional formulas of the present invention may comprise organic corn syrup solids. Corn syrup solids are partially hydrolyzed corn starch molecules that are dried to a low moisture powder. Corn syrup solids, as an ingredient class, are moderately sweet and have DE values of 20 or greater. Organic corn syrup solids having DE values of about 20 or greater are suitable for use herein. Non-limiting examples of some suitable sources of organic corn syrup solids include organic corn syrup solids from Agrana Beteiligungs-AG, Vienna, Austria; and organic corn syrup solids from Marroquin International, Santa Cruz, Calif., USA.

### Other Nutrients

The organic powder nutritional formulas of the present invention may comprise sufficient types and amounts of other nutrients to meet the targeted dietary needs of the intended user. These organic powder nutritional formulas may therefore comprise organic protein, organic carbohydrate, and organic lipid as described herein.

The amount of carbohydrate, protein, and lipid in the organic powder nutritionals of the present invention can vary considerably depending upon the dietary needs of the intended user as well as many other well known variables. These ingredients, however, are most typically formulated into the organic powders of the present invention with the ranges described in the following table.

Nutrient Ranges

| | First | Second | Third |
|---|---|---|---|
| Nutrient* | embodiment | embodiment | embodiment |
| Carbohydrate | 20-85 | 30-60 | 35-55 |
| % total calories | | | |
| Lipid | 5-70 | 20-45 | 25-35 |
| % total calories | | | |
| Protein | 10-75 | 20-50 | 25-40 |
| % total calories | | | |

*each numerical value is preceded by the term “about”

Different sources and types of organic lipids and organic proteins are known and can be used in the organic powder nutritional formulas of the present invention, provided that such nutrients are compatible with the added ingredients in the selected organic formula, are safe for their intended use, and do not otherwise unduly impair product performance.

The organic protein may be any organic protein source appropriate for use in an organic powder nutritional formula. Organic proteins suitable for use in the organic powder nutritional formulas include, but are not limited to, hydrolyzed, partially hydrolyzed or non-hydrolyzed proteins or protein sources, and can be derived from any known or otherwise suitable source such as milk (e.g., casein, whey), animal (e.g., meat, fish), cereal (e.g., rice, corn), vegetable (e.g., soy), or combinations thereof. The proteins for use herein can also include, or be entirely or partially replaced by, free amino acids known for use in organic powder nutritional products, non-limiting examples of which include tryptophan, glutamine, tyrosine, methionine, cysteine, arginine, and combinations thereof.

The organic protein for use herein may include organic non-fat dry milk supplied by a limited number of commercial sources which do not use hormones, steroids or antibiotics on the cattle and only feed organic grains and grasses to the cattle. Non-limiting examples of commercially available organic proteins suitable for use herein include organic non-fat dry milk from Humboldt Creamery, Fortuna, Calif., USA; organic non-fat dry milk from Chicago Dairy Corporation, Lake Forest, Ill., USA; organic non-fat dry milk from Organic Valley Farms, La Farge, Wis., USA; organic non-fat dry milk from Horizon Dairy, Boulder, Colo., USA; organic soy protein isolate from American Health and Nutrition, Inc., Ann Arbor, Mich., USA; and organic whey powder from Marroquin International, Santa Cruz, Calif., USA.

The organic lipid may be any organic lipid source appropriate for use in an organic powder nutritional formula. Non-limiting examples of organic lipids suitable for use herein include organic coconut oil from North Pacific, Portland, Oreg., USA; organic coconut oil from SK Food International, Inc., Fargo, N.D., USA; organic coconut oil from Spectrum Organic Products, Inc., Petaluma, Calif., USA; organic soy oil from North Pacific, Portland, Oreg., USA; organic soy oil from SK Food International, Inc., Fargo, N.D., USA; organic soy oil from Spectrum Organic Products, Inc., Petaluma, Calif., USA; organic high oleic sunflower oil from North Pacific, Portland, Oreg., USA; organic high oleic sunflower oil from SK Food International, Inc., Fargo, N.D., USA; organic high oleic sunflower oil from Spectrum Organic Products, Inc., Petaluma, Calif., USA; organic corn oil, organic olive oil, organic safflower oil, organic high oleic safflower oil, organic MCT (medium chain triglyceride) oil, organic sunflower oil, organic palm and palm kernel oils, organic palm olein, organic canola oil, organic marine oil, organic cottonseed oil, and combinations thereof.

The organic powder nutritional formulas of the present invention may further comprise vitamins, minerals or other ingredients suitable for use in a nutritional formula, however, these ingredients are rarely commercially available in organic form. Up to 5% (by weight, excluding water) of ingredients in nutritional products labeled as “organic” can be non-organic, provided these ingredients are not widely available in organic form. Protein, carbohydrate and lipid typically comprise greater than 95% (by weight, excluding water) of the ingredients in an organic nutritional formula, therefore, the vitamins, minerals and other minor ingredients in an organic powder nutritional formula can be non-organic provided that the ingredients or any component used in the manufacture of the ingredients are non-GMO.

The organic powder nutritional formulas of the present invention may further comprise any of a variety of vitamins, non-limiting examples of which include vitamin A, vitamin D, vitamin E, vitamin K, thiamine, riboflavin, pyridoxine, vitamin B12, niacin, folic acid, pantothenic acid, biotin, vitamin C, choline, carnitine, inositol, and derivatives thereof, and combinations thereof.

The organic powder nutritional formulas may further comprise any of a variety of minerals, non-limiting examples of which include calcium, phosphorus, magnesium, iron, zinc, manganese, copper, iodine, sodium, potassium, molybdenum, chromium, selenium, chloride, salts and derivatives thereof, and combinations thereof.

### Optional Ingredients

The organic powder nutritional formulas of the present invention may further comprise other optional ingredients that may modify the physical, chemical, aesthetic or processing characteristics of the compositions or serve as additional nutritional components when used in the targeted user population. Many such optional organic or non-GMO ingredients are known or are otherwise suitable for use in organic powder nutritional products and may also be used in the organic powder nutritional formulas of the present invention, provided that such optional materials are compatible with the essential materials described herein and are otherwise suitable for use in an organic powder nutritional formula.

Non-limiting examples of such optional organic or non-GMO ingredients include preservatives, additional anti-oxidants, polyunsaturated fatty acids, emulsifying agents, buffers, colorants, flavors, nucleotides and nucleosides, probiotics, prebiotics, lactoferrin and related derivatives, thickening agents and stabilizers, and so forth.

### Infant Formula Embodiments

The organic powder infant formula embodiments of the present invention preferably comprise nutrients in accordance with the relevant infant formula guidelines for the targeted consumer or user population, an example of which would be the Infant Formula Act, 21 U.S.C. Section 350(a).

The infant formula embodiments of the present invention include those formulas containing the organic carbohydrate, organic lipid, and organic protein concentrations described in the following table.

Organic Powder Infant Formula Macro Nutrients *

| | | | g/L |
|---|---|---|---|
| Nutrient | Embodiment | g/100 kcal | (reconstituted, as fed) |
| Carbohydrate | 1^{st} embodiment | 8-16 | 54-108 |
| | 2^{nd} embodiment | 9-13 | 61-88 |
| Lipid | 1^{st} embodiment | 3-8 | 20-54 |
| | 2^{nd} embodiment | 4-6.6 | 27-45 |
| Protein | 1^{st} embodiment | 1-6.0 | 7-41 |
| | 2^{nd} embodiment | 1.5-3.4 | 10-23 |

*all numerical values preceded by the term “about”

The infant formula embodiments of the present invention include those that comprise per 100 kcal of formula one or more of the following: vitamin A (from about 250 to about 1250 IU), vitamin D (from about 40 to about 150 IU), vitamin K (at least about 4 mcg), vitamin E (at least about 0.3 IU), vitamin C (at least about 8 mg), thiamine (at least about 8 mcg), vitamin B12 (at least about 0.15 mcg), niacin (at least about 250 mcg), folic acid (at least about 4 mcg), pantothenic acid (at least about 300 mcg), biotin (at least about 1.5 mcg), choline (at least about 7 mg), and inositol (at least about 4 mg).

The infant formula embodiments of the present invention include those that comprise per 100 kcal of formula one or more of the following: calcium (at least about 50 mg), phosphorus (at least about 25 mg), magnesium (at least about 6 mg), iron (at least about 0.15 mg), iodine (at least about 5 mcg), zinc (at least about 0.5 mg), copper (at least about 60 mcg), manganese (at least about 5 mcg), sodium (from about 20 to about 60 mg), potassium (from about 80 to about 200 mg), and chloride (from about 55 to about 150 mg).

### Product Form

The organic nutritional powders of the present invention are typically in the form of flowable or substantially flowable particulate compositions, or at least particulate compositions that can be easily scooped and measured with a spoon or similar other device, wherein the compositions can easily be reconstituted by the intended user with a suitable aqueous fluid, typically water, to form a liquid nutritional formula for immediate oral or enteral use. In this context, “immediate” use generally means within about 48 hours, most typically within about 24 hours, preferably right after reconstitution.

These organic nutritional powders include spray dried, agglomerated, dry mixed or other known or otherwise effective particulate form. The quantity of a nutritional powder required to produce a volume suitable for one serving can vary. Each may be packaged and sealed in single or multi-use containers, and then stored under appropriate conditions for up to about 36 months or longer, more typically from about 12 to about 24 months. For multi-use containers, these packages can be opened and then covered for repeated use by the ultimate user, provided that the covered package is then stored under appropriate conditions (e.g., avoid extreme temperatures) and the contents used within about one month or so.

### Methods of Use

The present invention is also directed to a method of providing an infant, toddler, child, or adult with their sole, primary, or supplemental nutrition needs. The method compromises reconstitution of the organic nutritional powder of the present invention with a suitable aqueous liquid, most typically water, followed by feeding or otherwise administrating the resulting nutritional liquid. Such dilution may be in an amount sufficient to provide a caloric density appropriate for the population to which the formula is directed.

The organic nutritional powders of the present invention are typically reconstituted to the desired caloric density or other suitable measure of dilution. Most common caloric densities for the organic infant formula embodiments of the present invention are generally at least about 19 kcal/fl oz (642 kcal/liter), more typically from about 20 kcal/fl oz (676 kcal/liter) to about 25 kcal/fl oz (845 kcal/liter), even more typically from about 20 kcal/fl oz (676 kcal/liter) to about 24 kcal/fl oz (811 kcal/liter). Generally, the 22-24 kcal/fl oz (744-811 kcal/liter) formulas are more commonly used in pre-term of low birth weight infants, and the 20-21 kcal/fl oz (676-710 kcal/liter) formulas are more often used in term infants. The quantity of an organic nutritional infant powder required to produce a volume suitable for one infant feeding can vary, but generally ranges from about 8 to about 9 grams of organic nutritional powder reconstituted with about 55 to about 65 ml of water to produce the desired nutrient densities. Non-infant and adult formulas may have any caloric density suitable for the targeted or intended population.

The present invention is also directed to a method of providing improved product dispersibility and less granular residue, by formulating or preparing the organic powder nutritional formulas of the present invention, with the selection and combination of carbohydrates organic sucrose, organic lactose, organic corn syrup, organic maltodextrin, and organic corn syrup solids, as described herein.

### Method of Manufacture

The organic powder nutritional formulas of the present invention may be prepared by any known or otherwise effective technique suitable for making and formulating an organic powder nutritional formula or similar other formula, variations of which may depend upon variables such as the selected ingredient combination, packaging and container selection, and so forth, for the desired organic powder nutritional formula. Such techniques and variations for any given formula are easily determined and applied by one of ordinary skill in the nutritional formulation or manufacturing arts.

The organic powder nutritional formulas of the present invention, including the exemplified formulas described hereinafter, can therefore be prepared by any of a variety of known or otherwise effective formulation or manufacturing methods. These methods most typically involve the initial formation of an aqueous slurry containing carbohydrates, proteins, lipids, stabilizers or other formulation aids, vitamins, minerals, or combinations thereof. The slurry is emulsified, pasteurized, homogenized, and cooled. Various other solutions, mixtures, or other materials may be added to the resulting emulsion before, during, or after further processing. The resulting emulsion is then heated and dried into powder form, which can be accomplished by spray drying or other heat-treating methods of forming solid particulates in a powder matrix. Other essential or optional materials can also be added to the formulation by dry blending, agglomerating, or otherwise combining the added material to the forming or just formed solid particulates.

Other suitable methods for making nutritional formulas are described, for example, in U.S. Pat. No. 6,365,218 (Borschel, et al.), U.S. Pat. No. 6,589,576 (Borschel, et al.), U.S. Pat. No. 6,306,908 (Carlson, et al.), U.S. Patent Application 20030118703 A1 (Nguyen, et al.), which descriptions are incorporated herein by reference.

The present invention therefore includes those embodiments directed to methods of making the organic nutritional powders described herein. The method comprising the steps of: (A) combining an organic lipid, an organic protein, and an organic carbohydrate, wherein the organic carbohydrate is a blend containing at least one first carbohydrate selected from the group consisting of organic maltodextrin, organic corn syrup solids, and organic corn syrup, and at least one second carbohydrate selected from the group consisting of organic sucrose and organic lactose, and (B) spray drying the combined ingredients to form an organic nutritional powder. Such methods include the manufacture of any formulation variation described herein.

### EXAMPLES

The following examples further describe and demonstrate specific embodiments within the scope of the present invention. The examples are given solely for the purpose of illustration and are not to be construed as limitations of the present invention, as many variations thereof are possible without departing from the spirit and scope of the invention. All exemplified amounts are weight percentages based upon the total weight of the composition, unless otherwise specified.

Each of the exemplified formulas is fed to humans to provide sole, primary, or supplemental nutrition. Each composition contains the carbohydrate blends as described herein, wherein each composition has improved dispersibility and improved physical appearance due to less granular residue.

### Examples 1-3

The following examples illustrate organic powder nutritional formulas of the present invention, including methods of making and using the organic formulas. Formula ingredients for each batch are listed in the following table.

| | Example 1 | Example 2 | Example 3 |
|---|---|---|---|
| | Quantity per | Quantity per | Quantity per |
| | 45,359 kg | 45,359 kg | 45,359 kg |
| Ingredients | (100,000 lbs) | (100,000 lbs) | (100,000 lbs) |
| Organic Non Fat Dry Milk | 13656 | 13656 | 13656 |
| (kg) | | | |
| Organic Maltodextrin (kg) | 11413 | — | 11413 |
| Organic Corn Syrup Solids | — | 11413 | — |
| (kg) | | | |
| Organic Sucrose (kg) | 6646 | 6646 | 6146 |
| Organic Lactose (kg) | — | — | 500 |
| Organic High Oleic Sunflower | 5238 | 5238 | 5238 |
| Oil | | | |
| Organic Soy Oil (kg) | 3799 | 3799 | 3799 |
| Organic Coconut Oil (kg) | 3749 | 3749 | 3749 |
| Potassium Citrate (kg) | 156.8 | 156.8 | 156.8 |
| Soy Lecithin (kg) | 131.4 | 131.4 | 131.4 |
| Nucleotide Choline Premix | 108.9 | 108.9 | 108.9 |
| (kg) | | | |
| Calcium Carbonate (kg) | 82.2 | 82.2 | 82.2 |
| Ascorbic Acid (kg) | 57.8 | 57.8 | 57.8 |
| Water Soluble Vitamin | 50.6 | 50.6 | 50.6 |
| Premix (kg) | | | |
| Magnesium Chloride (kg) | 30.3 | 30.3 | 30.3 |
| Sodium Chloride (kg) | 25.2 | 25.2 | 25.2 |
| Ferrous Sulfate (kg) | 21.4 | 21.4 | 21.4 |
| Choline Chloride (kg) | 19.6 | 19.6 | 19.6 |
| Ascorbyl Palmitate (kg) | 16.6 | 16.6 | 16.6 |
| Oil Soluble Vitamin Premix | 16.5 | 16.5 | 16.5 |
| (kg) | | | |
| Mixed Tocopherols (kg) | 7.3 | 7.3 | 7.3 |
| L-Carnitine (kg) | 1.2 | 1.2 | 1.2 |
| Riboflavin (g) | 144.3 | 144.3 | 144.3 |
| Beta-Carotene (g) | 16.8 | 16.8 | 16.8 |

All ingredients not designated as “organic” are non-GMO ingredients

The exemplified formula may be prepared by making at least two separate slurries that are later blended together, heat treated, standardized, heat treated a second time, spray dried, agglomerated and packaged. Initially, a carbohydrate-mineral slurry is prepared by dissolving the selected carbohydrates (e.g., organic maltodextrin, organic corn syrup solids, organic corn syrup, organic sucrose, organic lactose) in water at 60-71° C., followed by the addition of magnesium chloride, choline chloride, and sodium chloride. The resulting slurry is held under moderate agitation at 49-60° C. until it is later blended with the other prepared slurries.

An oil slurry is prepared by combining organic high oleic sunflower oil, organic soybean oil, and organic coconut oil at 49-60° C., followed by the addition of ascorbyl palmitate, mixed tocopherols, soy lecithin, beta-carotene, oil soluble vitamin premix, and calcium carbonate. The resulting oil slurry is held under moderate agitation at 38-49° C. until it is later blended with the other prepared slurries.

A protein slurry is prepared by dissolving organic non-fat dry milk in water at approximately 5-30° C. The resulting protein slurry is held under low agitation at 2-7° C. until it is later blended with the other prepared slurries.

Water, the carbohydrate-mineral slurry, and the protein slurry are combined under adequate agitation. The oil slurry is then added. The pH of the resulting blend is adjusted with potassium hydroxide. This blend is held under moderate agitation at 49-60° C.

The resulting blend is heated to 71-77° C., emulsified to a maximum of 300 psig, and then heated to 82-88° C., for about 5 seconds. The heated blend is passed through a flash cooler to reduce the temperature and then through a plate cooler to further reduce the temperature to 71-77° C. The cooled blend is then homogenized at 2400-2600/400-600 psig, and then cooled to 2-7° C. Samples are taken for microbiological and analytical testing. The mixture is held under agitation.

A water-soluble vitamin (WSV) solution and an ascorbic acid solution are prepared separately and added to the processed blended slurry. The vitamin solution is prepared by adding the following ingredients to water with agitation: potassium citrate, ferrous sulfate, WSV premix, L-carnitine, riboflavin, and the nucleotide-choline premix. The ascorbic acid solution is prepared by adding potassium hydroxide and ascorbic acid to a sufficient amount of water to dissolve the ingredients. The ascorbic acid solution pH is then adjusted to 5-9 with potassium hydroxide.

The blend pH may be adjusted with potassium hydroxide to achieve optimal product stability. The blend then receives a second heat treatment. The blend is originally heated to 71-77° C., and then further heated to 116-127° C. for about 5 seconds. The heated blend is then passed through a flash cooler to reduce the temperature to 71-82° C. Following heat treatment, the blend is evaporated.

The evaporated blend is passed through a spray drier. The finished powder then undergoes agglomeration with water as the binder solution. The completed product is then packaged into suitable containers.

At least 95% of the formula ingredients, on a dry weight basis, are organic. This particular formula is reconstituted and stored in a clear plastic container for 0-24 hours prior to use. The formula shows no signs, even after 0-24 hours, of excessive granular residue on the clear interior surface of the formula container. Product dispersibility is likewise maintained.

The resulting formula is then used to provide a supplemental, primary, or sole source of nutrition to infants or other appropriate individuals.

### Experiment

A study is conducted to evaluate and compare the physical appearance (i.e. granular residue) and dispersibility of organic powder infant formulas containing either organic maltodextrin or a blend of organic maltodextrin and organic sucrose. These organic infant formulas are compared to a non-organic powder infant formula containing non-organic maltodextrin.

The study formula base is Similac® Advance® powder infant formula, in either organic or non-organic form, with modified organic carbohydrate sources. The three experimental formulas are described in the following table.

| Sample | Sample A | Sample B | Sample C |
|---|---|---|---|
| Product Type | Organic powder | Organic powder | Non-organic |
| | infant formula | infant formula | powder infant |
| | | | formula |
| Carbohydrate | 100% organic | 63.2% organic | 100% non- |
| blend, % by | maltodextrin | sucrose, 36.8% | organic |
| weight | | organic | maltodextrin |
| | | maltodextrin | |

The physical appearance and dispersibility of the three formulations are evaluated in accordance with the methods described hereinafter. These include granular residue, dispersibility, and 80 mesh evaluations.

### Granular Residue

The granular residue evaluation is directed to a method for quantifying the amount of granular residue coating on the sides of a bottle after reconstitution of a powder nutritional formula. Samples are prepared by filling an 8 oz. clear bottle up to the 4 oz. mark with 65° C. tap water. Approximately 17 grams of sample powder is added to the water and the bottle is capped. The sample is shaken by hand in an up and down motion for 15 seconds. The sides of the bottle are then visually assessed and assigned a rating in accordance with standard photograph examples and the 6-point scale described in the following table.

| Rating | Description of Granular Residue Ratings |
|---|---|
| 1 | No granular residue visible |
| 2 | Very slight granular residue, only visible upon close |
| | inspection |
| 3 | Slight granular residue, numerous areas of clearing present |
| 4 | Moderate, granular residue, few areas of clearing present |
| 5 | Moderate to severe granular residue, completely coats sides |
| | of bottle |
| 6 | Severe granular residue, multiple layers, completely coats sides |
| | of bottle |

Following the 0 hour evaluation, samples are stored in the refrigerator until evaluated at the next interval. During storage, samples are periodically shaken. In addition to a 0 hour evaluation, samples are evaluated at 1, 6, and 24 hours, as typical infant formula product instructions specify that reconstituted product should be used within 24 hours of preparation.

In this particular experiment, the three formulations are tested using the granular residue method described above. Samples A, B, and C are each run in duplicate.

The granular residue results are summarized in the following table:

| | | Product Type | | |
|---|---|---|---|---|
| | | Organic | Organic | Non-organic |
| | | powder | powder infant | powder infant |
| | | infant formula | formula | formula |
| | | Carbohydrate blend, % by weight | | |
| | | | 63.2% organic | |
| | | | sucrose, | 100% non- |
| | | 100% organic | 36.8% organic | organic |
| Elapsed | Run | maltodextrin | maltodextrin | maltodextrin |
| Time | Number | Sample A | Sample B | Sample C |
| 0 hour | 1 | 5 | 3 | 3 |
| | 2 | 5 | 3 | 3 |
| 1 hour | 1 | 4 | 3 | 3 |
| | 2 | 5 | 3 | 3 |
| 6 hours | 1 | 4 | 2 | 3 |
| | 2 | 5 | 2 | 3 |
| 24 hours | 1 | 6 | 2 | 2 |
| | 2 | 6 | 2 | 2 |

As shown in the above data table, less granular residue occurs for the organic powder infant formula containing a blend of organic maltodextrin and organic sucrose (Sample B) than for the organic powder nutritional formulation containing organic maltodextrin as the carbohydrate source (Sample A). The granular residue results for the organic powder infant formula containing a blend of organic maltodextrin and organic sucrose (Sample B) are comparable to the results for the non-organic powder infant formula containing non-organic maltodextrin (Sample C).

### Dispersibility

The dispersibility evaluation is directed to a method for quantifying the degree of solubility of a nutritional product. In this particular experiment, the three samples (Samples A, B, C) described above in the granular residue evaluation are subsequently used in this dispersibility evaluation. Three identical batches of Sample A, two identical batches of Sample B, and one batch of Sample C are evaluated.

Samples are prepared by filling an 8 oz. bottle with 180 mL of tap water. Approximately 34 grams of sample powder is added to the water and the bottle is capped. The sample is shaken in a mechanical shaker for 10 seconds at 4 cycles per second. The sample is poured through an 80 mesh screen. The 8 oz. bottle is filled with 2 oz. of tap water to dislodge any particles that remain in the bottle and poured through an 80 mesh screen. The samples are rated and assigned a numerical score based on the number and size of particles that remain on the 80 mesh screen, in accordance with standard photograph examples and the 6-point scale described in the following table:

| Rating | Description of Dispersibility Ratings |
|---|---|
| 1 | No particles |
| 2 | First evidence of very small particles to a slight amount of |
| | small particles with a maximum size of approximately 1.0 mm |
| 3 | Slight amount of small particles with a few moderate size |
| | particles |
| 4 | Moderate amount of medium sized particles with a moderate |
| | amount of small particles |
| 5 | A heavy amount of varying sized particles covering |
| | most of the sieve screen |
| 6 | An excessive amount of any sized particles which cover |
| | the entire sieve screen and may plug the screen openings. |

Samples are run in duplicate and an average result is reported. The dispersibility results are summarized in the following table:

| Product Type | Organic powder infant formula | | | Organic powder infant | | Non-organic |
|---|---|---|---|---|---|---|
| | | | | formula | | powder infant |
| | | | | | | formula |
| Carbohydrate | 100% organic maltodextrin | | | 63.2% organic sucrose, | | 100% non- |
| blend, % by | | | | 36.8% organic | | organic |
| weight | | | | maltodextrin | | maltodextrin |
| Sample | Sample A | Sample A | Sample A | Sample B | Sample B | Sample C |
| | Batch 1 | Batch 2 | Batch 3 | Batch 1 | Batch 2 | |
| Dispersibility | 5.5 | 6.0 | 6.0 | 2.5 | 3.0 | 2.0 |
| Rating | | | | | | |

As shown in the above data table, the organic powder infant formula containing a blend of organic maltodextrin and organic sucrose (Sample B) displayed improved dispersibility as compared to the organic powder infant formula containing organic maltodextrin (Sample A). The dispersibility results for the organic powder infant formula samples containing a blend of organic maltodextrin and organic sucrose (Sample B) are comparable to the dispersibility results for the non-organic powder infant formula containing 100% non-organic maltodextrin (Sample C).

### 80 Mesh

80 mesh evaluation is a widely used method to determine the degree of solubility of a nutritional product. In this particular experiment, the three samples (Samples A, B, C) described above in the granular residue evaluation are subsequently used in this 80 mesh evaluation. Three identical batches of Sample A, two identical batches of Sample B, and one batch of Sample C are evaluated.

Samples are prepared by filling an 8 oz. bottle with 180 mL of tap water. Approximately 34 grams of sample powder is added to the water and the bottle is capped. The sample is shaken by hand in an up and down motion for 30 seconds. The sample is poured through an 80 mesh screen. The 8 oz. bottle is completely filled with tap water to dislodge any particles that remain in the bottle and poured through the 80 mesh screen. The 80 mesh screen is rinsed with water for 3 seconds. The samples are rated and assigned a numerical score based on the number and size of particles that remain on the 80 mesh screen, in accordance with standard photograph examples and the 6-point scale described in the following table:

| Rating | Description of 80 Mesh Ratings |
|---|---|
| 1 | No particles |
| 2 | First evidence of very small particles to a slight amount of |
| | small particles with a maximum size of approximately 1.0 mm |
| 3 | Slight amount of small particles with a few moderate size |
| | particles |
| 4 | Moderate amount of medium sized particles with a moderate |
| | amount of small particles |
| 5 | A heavy amount of varying sized particles covering most of the |
| | sieve screen |
| 6 | An excessive amount of any sized particles which cover |
| | the entire sieve screen and may plug the screen openings. |

Samples are run in duplicate and an average result is reported. The 80 mesh results are summarized in the following table:

| Product Type | Organic powder infant formula | | | Organic powder infant | | Non-organic |
|---|---|---|---|---|---|---|
| | | | | formula | | powder infant |
| | | | | | | formula |
| Carbohydrate | 100% organic maltodextrin | | | 63.2% organic sucrose, | | 100% non- |
| blend, % by | | | | 36.8% organic | | organic |
| weight | | | | maltodextrin | | maltodextrin |
| Sample | Sample A | Sample A | Sample A | Sample B | Sample B | Sample C |
| | Batch 1 | Batch 2 | Batch 3 | Batch 1 | Batch 2 | |
| 80 Mesh | 6 | 6 | 6 | 3 | 2 | 2 |
| Rating | | | | | | |

The 80 mesh data is consistent with the above-described dispersibility data, and shows that the organic powder infant formula containing a blend of organic maltodextrin and organic sucrose (Sample B) is more dispersible than the organic powdered infant formula containing organic maltodextrin (Sample A). The 80 mesh results for the organic powder infant formula containing a blend of organic maltodextrin and organic sucrose (Sample B) are comparable to the dispersibility results for the non-organic powder infant formula containing 100% non-organic maltodextrin (Sample C).

### Conclusion

The data as set forth herein shows that organic powder infant formulas containing the carbohydrate blend of the present invention have improved dispersibility and improved physical appearance, due to less granular residue, as compared to organic powder infant formulas containing maltodextrin. The organic powder infant formulas of the present invention exhibit granular residue and dispersibility results that are comparable to non-organic infant formulas.

The data suggests that the residue and dispersibility problem is uniquely associated with the organic formulas, not the non-organic formulas. The data also demonstrate that this dispersibility problem is resolved in the organic formulas by the selection of the carbohydrate blends as described herein.

What is claimed is:

1. A composition comprising
(a) organic lipid;
(b) organic protein; and
(c) organic carbohydrate, wherein the organic carbohydrate is a blend containing
(i) at least one first carbohydrate selected from the group consisting of organic maltodextrin, organic corn syrup solids, and organic corn syrup, and
(ii) at least one second carbohydrate selected from the group consisting of organic sucrose and organic lactose,
wherein the composition is an organic nutritional formula in powder form.

2. The composition of claim 1 wherein the composition has a weight ratio of the first carbohydrate to the second carbohydrate from about 1:10 to about 10:1.

3. The composition of claim 1 wherein the weight ratio of the first carbohydrate to the second carbohydrate is from about 3:1 to about 1:1.

4. The composition of claim 1 wherein the first carbohydrate comprises organic maltodextrin and the second carbohydrate comprises organic sucrose.

5. The composition of claim 1 wherein the composition is substantially free of added organic lactose.

6. The composition of claim 4 wherein the weight ratio of the organic maltodextrin to the organic sucrose is from about 1:10 to about 10:1.

7. The composition of claim 4 wherein the weight ratio of the organic maltodextrin to the organic sucrose is from about 3:1 to about 1:1.

8. The composition of claim 1 wherein the organic maltodextrin is organic corn maltodextrin.

9. The composition of claim 1 wherein the composition comprises, as a percentage of total calories, from about 30% to about 60% carbohydrate, from about 20% to about 45% lipid, and from about 20% to about 50% protein.

10. A composition comprising
(a) organic lipid;
(b) organic protein; and
(c) organic carbohydrate, wherein the organic carbohydrate is a blend containing
(i) at least one first carbohydrate selected from the group consisting of organic maltodextrin, organic corn syrup solids, and organic corn syrup, and
(ii) at least one second carbohydrate selected from the group consisting of organic sucrose and organic lactose,
wherein the composition is an organic infant formula in powder form.

11. The composition of claim 10 wherein the composition has a weight ratio of the first carbohydrate to the second carbohydrate from about 1:10 to about 10:1.

12. The composition of claim 10 wherein the weight ratio of first carbohydrate to the second carbohydrate is from about 3:1 to about 1:1.

13. The composition of claim 10 wherein the first carbohydrate comprises organic maltodextrin and the second carbohydrate comprises organic sucrose.

14. The composition of claim 10 wherein the composition is substantially free of added organic lactose.

15. The composition of claim 13 wherein the weight ratio of organic maltodextrin to organic sucrose is from about 1:10 to about 10:1.

16. The composition of claim 13 wherein the weight ratio of organic maltodextrin to organic sucrose is from about 3:1 to about 1:1.

17. The composition of claim 10 wherein the composition has a caloric density of from about 642 to about 1014 kcal/liter, on a ready-to-feed basis.

18. The composition of claim 10 wherein the organic maltodextrin is organic corn maltodextrin.

19. The composition of claim 10 wherein the composition comprises, as a percentage of total calories, from about 30% to about 60% carbohydrate, from about 20% to about 45% lipid, and from about 20% to about 50% protein.

20. A method of providing nutrition to an individual in need thereof, comprising administering to the individual the composition of claim 1.

21. A method of providing nutrition to an infant in need thereof, comprising administering to the infant the composition of claim 10.

22. A method of making an organic nutritional powder, said method comprising the steps of:
(A) combining organic lipid, organic protein, and organic carbohydrate, wherein the organic carbohydrate is a blend containing
(i) at least one first carbohydrate selected from the group consisting of organic maltodextrin, organic corn syrup solids, and organic corn syrup, and
(ii) at least one second carbohydrate selected from the group consisting of organic sucrose and organic lactose,
(B) spray drying the combined ingredients to form an organic nutritional powder.
